(19) United States
(12) Patent Application Publication
(10) Pub. No.: US 2018/0071951 A1
(43) Pub. Date: Mar. 15, 2018

(54) HOT PRESS APPARATUS AND METHOD FOR PRODUCING SINTERED PRODUCT

(71) Applicant: BRIDGESTONE CORPORATION, Tokyo (JP)

(72) Inventor: Kazuhito HASE, Tokyo (JP)

(73) Assignee: BRIDGESTONE CORPORATION, Tokyo (JP)

(21) Appl. No.: 15/558,810

(22) PCT Filed: Mar. 18, 2016
(86) PCT No.: PCT/JP2016/058696

§ 371 Date: Sep. 15, 2017

(30) Foreign Application Priority Data
Mar. 18, 2015 (JP) 2015-054346

(51) Int. Cl. B28B 3/02; B30B 11/02; C04B 35/645; B30B 15/02

(52) U.S. Cl. CPC B28B 3/02; B30B 15/02; C04B 35/645; B30B 11/02

(57) ABSTRACT

A hot press apparatus includes a mold including: a cylindrical die, a cylindrical outer sleeve provided inside the die, and a cylindrical inner sleeve provided inside the outer sleeve; and a pair of pressing punches for pressing a sample filled into the mold. The inner sleeve has lower rigidity than the outer sleeve and is provided with a graphite sheet member including graphite on the inner side of the mold. The hardness of the outer sleeve is preferably 30 HSD or greater.

### TECHNICAL FIELD

The present invention relates to a hot press apparatus and a method for producing a sintered product.

### BACKGROUND ART

There are known hot press apparatuses including cylindrical molds open on both sides and methods for producing sintered products with the hot press apparatuses by sintering powder material as a raw material of the sintered products by heating under pressure (refer to Patent Literature 1).

In a method for producing a sintered product with such a hot press apparatus, powder material is placed in a cylindrical mold, and then sintered by heating under pressure with a pair of pressing punches placed at both ends inside the mold, so as to produce a sintered product. The outer periphery of the mold is covered with a cylindrical support member during the production of the sintered product so that the mold is not deformed by the pressure caused by the pressing punches. The support member has rigidity to withstand the pressure, which prevents the mold from expanding outward by the pressure.

### CITATION LIST

### Patent Literature

Patent Literature 1: Japanese Unexamined Patent Application Publication No, 2001-048659

### SUMMARY OF INVENTION

The size (diameter) of sintered products such as silicon carbide members has been increasing in recent years. The method for producing a sintered product with such a conventional hot press apparatus has problems of interruption of flow of powder along the outer periphery of the sintered product, cracks caused on the inner periphery of the mold, and poor detachability between the sintered product and the inside of the mold. The problems limit an increase in production yield. The interruption of flow of the powder along the outer periphery of the sintered product or the occurrence of cracks on the inner periphery of the mold causes local low-density areas on the outer periphery of the sintered product, which may lead to a defective product.

An object of the present invention is to provide a hot press apparatus and a method for producing a sintered product with a size or diameter increased while preventing a defective product and improving a production yield to make efficient use of material.

For solving the conventional problems described above, an embodiment of the present invention has the following aspects:

(1) A first aspect is a hot press apparatus including: a mold including a cylindrical die, a cylindrical outer sleeve provided inside the die, and a cylindrical inner sleeve provided inside the outer sleeve; and a pair of pressing punches for pressing a sample filled into the mold, the inner sleeve having lower rigidity than the outer sleeve,

the inner sleeve being provided with a sheet including graphite on an inner side of the mold.

(2) A second aspect is the hot press apparatus according the first aspect, wherein a hardness of the outer sleeve is 30 HSD or greater.

(3) A third aspect is a method for producing a sintered product by use of the hot press apparatus according to the first or second aspect.

### Advantageous Effects

The embodiment of the present invention can provide a hot press apparatus and a method for producing a sintered product, capable of preventing a defective product and improving a production yield to make efficient use of material.

### BRIEF DESCRIPTION OF DRAWINGS

FIG. 1 is a schematic view showing a hot press apparatus according to the present embodiment.

### DESCRIPTION OF EMBODIMENTS

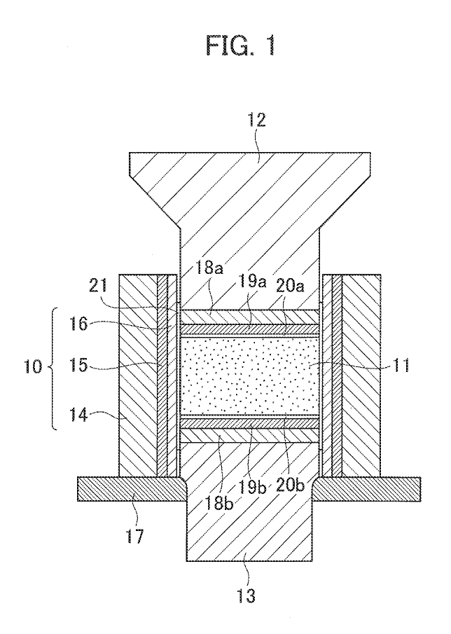

A hot press apparatus and a method for producing a sintered product according to the embodiment of the present invention will be described below. FIG. 1 is a schematic, view showing the hot press apparatus according to the present embodiment. The hot press apparatus includes a mold 10 including: a cylindrical die 14, a cylindrical outer sleeve 15 provided inside the die 14, and a cylindrical inner sleeve 16 provided inside the outer sleeve 15; and a pair of pressing punches 12 and 13 for pressing a sample 11 filled into the mold 10. The inner sleeve 16 has lower rigidity than the outer sleeve 15 and is provided with a graphite sheet member 21 including graphite on the inner side of the mold 10. The hardness of the outer sleeve 15 is preferably 30 HSD or greater, more preferably 40 HSD or greater. According to the present embodiment, the graphite sheet member 21 is composed of graphite.

As used herein, the rigidity denotes a degree of resistance a change in dimension (deformation), with respect to bending or torsion, represented by an elastic modulus or hardness such as a Young's modulus or stiffness.

The mold 10 to be filled with the sample 11 is designed in the present embodiment to have the dimensions of 300 mm or greater in diameter and 50 mm or greater in height so as to cope with an increase in size or diameter of a sintered product. As used herein, the “height” is also referred to as a thickness for a sintered product.

The mold 10 is provided at one end with a mount 17 on which the mold 10 is installed. Although not shown in FIG. 1, the mold 10 includes a heating unit for heating the sample 11 filled into the mold 10.

The pressing punches 12 and 13 placed at both ends inside the hold 10 are provided, sequentially on the pressing surfaces thereof, with spacers 18a and 18b, powder leakage prevention sheets 19a and 19b, and graphite sheet members 20a and 20b, respectively. The graphite sheet members 20a and 20b composed of graphite are preferably provided in order to increase detachability between the mold 10 and the sintered product after hot-pressed.

The hot press apparatus according to the present embodiment produces the sintered product (such as a silicon carbide sintered product) in a manner such that the mold 10 is filled with the sample 11, and the sample 11 is sintered by heating under pressure with the pressing punches 12 and 13.

The sample 11 used in the hot press apparatus according to the present embodiment may be any conventionally known powder material (such as powder material for a silicon carbide sintered product). The conditions for pressure application and sintering in the hot press apparatus according to the present embodiment may be any conventionally known conditions.

The die 14 is preferably formed into a cylindrical shape having a height of 300 mm or greater and a thickness of 30 mm or greater and formed of a carbon fiber reinforced-carbon composite material. The outer sleeve 15 provided inside the die 14 and the inner sleeve 16 provided inside the outer sleeve 15 each have a single layer structure as shown in FIG. 1 but may have a double-layered or multiple-layered structure. The outer sleeve 15 and the inner sleeve 16 preferably have the total thickness of 20 mm or greater, and are each preferably a graphite member. The outer sleeve 15 and the inner sleeve 16 are preferably separated from each other at two or more positions along the respective layers.

The inner sleeve 16 has lower rigidity than the outer sleeve 15. The hardness of the outer sleeve 15 is preferably 30 HSD or greater. The inner sleeve 16 having lower rigidity than the outer sleeve 15 can be prevented from cracking when a sintered product to be produced having an increased size or diameter (for example, 300 mm or greater in diameter, and 50 mm or greater in height or thickness) is repeatedly subjected to pressure application and sintering. The prevention of cracks on the inner sleeve 16 prevents the material of the sintered product from entering the cracks to cause a resistance impeding the molding of the sintered product, so as to prevent local low-density areas on the outer periphery of the sintered product around the cracks caused on the inner sleeve 16. The prevention of cracks on the inner sleeve 16 further prevents an entrance of foreign matter and a loss of the powder material (the sample 11). Accordingly, the hot press apparatus according to the present embodiment can prevent a defective product and improve a production yield to make efficient use of the material when the size or diameter of a sintered product to be produced is increased.

The inner sleeve 16 is provided with the graphite sheet member 21 with a thickness of 1 mm or less on the inner side of the mold 10, so that the powder material is directly brought into contact with the graphite sheet member 21, instead of the inner periphery of the inner sleeve 16. The graphite sheet member 21 contributes to smooth sliding of the outer periphery of the sintered product along the inner periphery of the mold 10, namely, along the graphite sheet member 21, and improves the flow of the powder, so as to prevent local low-density areas on the outer periphery of the sintered product more accurately even when the sintered product is increased in size or diameter (for example, 300 mm or greater in diameter, and 50 mm or greater in height (thickness)). The graphite sheet member 21 further facilitates separation or release of the sintered product after hot-pressed from the mold 10. Accordingly, a defective product can be prevented and the production yield is improved to make efficient use of the material.

The powder leakage prevention sheets 19a and 19b each preferably have a structure including at least one layer of a carbon fiber reinforced-carbon composite material or a felt carbon member each having a thickness of 3 mm or greater. The diameter of the powder leakage prevention sheets 19a and 19b is preferably larger by approximately 0 mm to 3 mm than or the same as the cross section of the mold 10. The powder leakage prevention sheets 19a and 19b having such a configuration are flattened to some extent and spread out when the sample is pressed by the pressing punches 12 and 13, so as to sufficiently adhere the inner peripheral surface (the inner wall) of the mold 10 to effectively prevent powder leakage. Accordingly, the production yield and the performance of the sintered product to be obtained can be improved, and dirt or deformation of the members (such as the elements of the mold and the pressing punches) can be prevented.

A method for producing a sintered product according to the present embodiment is particularly a method for producing a sintered product (such as a silicon carbide sintered product) by use of the hot press apparatus according to the present embodiment as described above.

The method for producing a sintered product according to the present embodiment may follow the conditions for pressure application and sintering as described in JP 11.10-067565 and JP H10-163079 filed by the Applicant of the present application in which a silicon carbide sintered product is produced by hot press sintering by use of a nonmetal auxiliary agent.

### EXAMPLES

The hot press apparatus is further described below with reference to Example and Comparative Examples. It should be understood that the present invention is not intended to be limited to those examples.

### Example 1

A hot press apparatus of Example 1 as shown in FIG. 1 was obtained such that the inner diameter of the mold 10 to be filled with the sample 11 was set at 300 mm, and a carbon fiber reinforced-carbon composite material was used for the die 14 and the spacers 18a and 18b. A silicon carbide sintered product having a diameter of 300 mm and a height (thickness) of 50 mm was obtained with the hot press apparatus of this example. The repeated pressure application and sintering did not cause cracks on the inner sleeve 16 in Example 1.

### Comparative Example 1

A hot press apparatus of Comparative Example 1 similar to that of Example 1 was obtained except that the inner sleeve 16 had substantially the same rigidity as the outer sleeve 15, and that the graphite sheet member 21 was not provided. A silicon carbide sintered product was obtained with the hot press apparatus of Comparative Example 1 in the same manner as Example 1 so as to have the same dimensions. The repeated pressure application and sintering caused cracks on the inner sleeve 16 in Comparative Example 1.

### Comparative Example 2

A hot press apparatus of Comparative Example 2 similar to that of Example 1 was obtained except that the graphite sheet member 21 was not provided. A silicon carbide sintered product was obtained with the hot press apparatus of Comparative Example 2 in the same manner as Example 1 so as to have the same dimensions. The repeated pressure application and sintering did not cause cracks on the inner sleeve 16 in Comparative Example 2.

Table 1 summarizes the measurement results indicating the entire density and a local density (a minimum value) of the silicon carbide sintered product and also the evaluation results obtained in each of Example 1 and Comparative Examples 1 and 2.

TABLE 1

| | | | Comparative | Comparative |
|---|---|---|---|---|
| | | Example 1 | Example 1 | Example 2 |
| Hot Press | Inner Sleeve 16 | 40 HSD | 50 HSD | 40 HSD |
| Apparatus | Outer Sleeve 15 | 50 HSD | 50 HSD | 50 HSD |
| | Graphite Sheet | Present | None | None |
| | Member 21 | | | |
| | Cracks on Sleeve | None | Present | None |
| Sintered | Evaluation of | Superior | Inferior | Slightly |
| Product | Product | | | Inferior |
| | Density (entire) | 3.15 | 3.05 | 3.14 |
| | [g/cm³] | | | |
| | Density (local, MIN) | 3.13 | 2.70 | 3:10 |
| | [g/cm³] | | | |

As shown in Table 1, the silicon carbide sintered product of Example 1 has the entire density greater than those in Comparative Examples 1 and 2, has a difference between the entire density and the local density much smaller than those in Comparative Examples 1 and 2, and is superior to the products of Comparative Examples 1 and 2. The hot press apparatus of Example 1 clearly sufficiently prevents local low-density areas on the outer periphery of the sintered product, as compared with Comparative Examples 1 and 2. The prevention of occurrence of local low-density areas is derived from the improvement of flow of the powder along the outer periphery of the sintered product due to the graphite sheet member 21 leading to smooth sliding of the outer periphery of the sintered product along the inner periphery of the mold 10, and derived from the prevention of cracks on the inner sleeve 16. The smooth sliding of the outer periphery of the sintered product along the inner periphery of the mold 10 also facilitates the separation or release of the sintered product after hot-pressed from the mold 10, so as to further prevent a defective product.

The silicon carbide sintered product obtained in Comparative Example 1 has the entire density lower than those in Example 1 and Comparative Example 2, has a difference between the entire density and the local density larger than those in Example 1 and Comparative Example 2, and is inferior to the products of Example 1 and Comparative Example 2. The inferiority is because cracks were caused on the inner sleeve 16 and the material of the sintered product entered the cracks on the inner sleeve 16, which caused a resistance impeding the molding of the sintered product to result in local low-density areas on the outer periphery of the sintered product around the cracks caused on the inner sleeve 16. In addition, since the graphite sheet material 21 is not provided on the inner surface of the inner sleeve 16, the flow of the powder along the outer periphery of the sintered product is not improved, which is also a cause of the occurrence of the local low-density areas on the outer periphery of the sintered product. The cracks caused on the inner sleeve 16 may lead to an entrance of foreign matter and a loss of the sample 11 (the powder material) to result in a defective product.

The silicon carbide sintered product obtained in Comparative Example 2 has the entire density higher than that in Comparative Example 1 but lower than that in Example 1. The difference between the entire density and the local density in Comparative Example 2 is smaller than that in Comparative Example 1 but larger than that in Example 1. Since the graphite sheet material 21 is not provided on the inner surface of the inner sleeve 16 in Comparative Example 2, the flow of the powder along the outer periphery of the sintered product is not improved, which is a cause of the occurrence of the local low-density areas on the outer periphery of the sintered product.

The hot press apparatus of Example 1 has a configuration in which the inner sleeve 16 has lower rigidity than the outer sleeve 15 and is provided with the graphite sheet material 21 on the inner side of the mold 10, as described above. This configuration can prevent cracks on the inner sleeve 16 and ensure smooth sliding of the outer periphery of the sintered product along the inner periphery of the mold 10. The hot press apparatus of Example 1 thus prevents the occurrence of local low-density areas on the outer periphery of the sintered product to be produced when the size or diameter of the sintered product is increased (300 mm in diameter, 50 mm in height (thickness)). The hot press apparatus of Example 1 also prevents an entrance of foreign matter and a loss of the sample 11 (the powder material) and facilitates the separation or release of the sintered product after hot-pressed from the mold 10. Accordingly, the hot press apparatus of Example 1 can prevent a defective product and improve a production yield to make efficient use of the material even in the case in which the sintered product to be produced is increased in size or diameter.

This application claims the benefit of Japanese Patent Application No. 2015-054346, filed on Mar. 18, 2015, the entire contents of which are incorporated herein by reference.

### INDUSTRIAL APPLICABILITY

The present invention can prevent a defective product and improve a production yield to make efficient use of material even in the case in which a sintered product to be produced is increased in size or diameter.

### REFERENCE SIGNS LIST

10 MOLD
11 SAMPLE
12, 13 PRESSING PUNCH
14 DIE
15 OUTER SLEEVE
16 INNER SLEEVE
17 MOUNT
18a, 18b SPACER
19a, 19b POWDER LEAKAGE PREVENTION SHEET
20a, 20b GRAPHITE SHEET MEMBER
21 GRAPHITE SHEET MEMBER

1. A hot press apparatus comprising:
a mold including a cylindrical die, a cylindrical outer sleeve provided inside the die, and a cylindrical inner sleeve provided inside the outer sleeve; and
a pair of pressing punches for pressing a sample filled into the mold,
the inner sleeve having lower rigidity than the outer sleeve,
the inner sleeve being provided with a sheet including graphite on an inner side of the mold.

2. The hot press apparatus according to claim 1, wherein a hardness of the outer sleeve is 30 HSD or greater.

3. A method for producing a sintered product by use of the hot press apparatus according to claim 1.

4. A method for producing a sintered product by use of the hot press apparatus according to claim 2.
